(19) United States
(12) Patent Application Publication
(10) Pub. No.: US 2016/0110001 A1
(43) Pub. Date: Apr. 21, 2016

(54) INTERACTIVE DISPLAY SYSTEM

(71) Applicant: Caterpillar Inc., Peoria, IL (US)

(72) Inventor: Richard A. Matzelle, Peoria, IL (US)

(73) Assignee: Caterpillar Inc., Peoria, IL (US)

(21) Appl. No.: 14/979,605

(22) Filed: Dec. 28, 2015

(51) Int. Cl. G06F 3/041; G06F 3/0484; G06F 3/0481

(52) U.S. Cl. CPC G06F 3/0412; G06F 3/04817; G06F 3/04842; G06F 2203/04103

(57) ABSTRACT

An interactive display system including a first assembly, a touch screen assembly and a display assembly is provided. The first assembly includes a glass sheet having a first surface and a second surface. The glass sheet is etched at one or more of the first surface and the second surface. The first assembly further includes a first coating, a second coating, a third coating, a fourth coating, and a fifth coating. The first coating, the second coating and the third coating are applied at the first surface of the glass sheet. The fourth coating and the fifth coating are applied at the second surface of the glass sheet. The touch screen assembly includes a touch screen and is optically bonded to the glass sheet at the second surface of the glass sheet. The display assembly is optically bonded to the touch screen assembly.

### TECHNICAL FIELD

The present disclosure relates to an interactive display system, and more specifically, to the interactive display system including a first assembly.

### BACKGROUND

Touch screen displays find their application in a variety of vehicles such as, but not limited to passenger cars, locomotives, construction machines etc. A touch screen is used for providing input to the machine, and also for receiving an output on the display, thereby making it very convenient for an operator of a construction machine. Typically, a touch screen display includes a display at the base and a touch screen over the display. The display further includes multiple components such as, a backlight, one or more polarizer layers etc. Similarly, depending on the type, the touch screen further includes multiple components such as a glass layer.

The existing design of the touch screen display has several disadvantages. The multiple layers bonded together with adhesives have different indices of refraction, which results in undesired reflectance in the display system, in turn reducing the contrast and the readability of the touch screen display. Further, the current touch screen systems are not suitable for high ambient light conditions, which are typically encountered in the construction machine. This in turn makes it difficult for the operator of the construction machine to read the display, and consequently, the operator may miss an important warning message. Therefore, there is a need for a touch screen with improved viewing characteristics.

United States Publication Number 20080266273 discloses an interactive display system including a display assembly, a touch sensor overlay and an optical layer interposed between the touch sensor overlay and the display assembly. The interactive display system includes multiple layers including a polarizer, and a quarter wave retarder. The touch sensor overlay may further include additional film coatings, such as hard coat film, anti-reflection film, anti-glare film, anti-smudge film and anti-fingerprint film. However, such a screen is not suitable for construction machines that work in outdoor environment. Further, in outdoor environment, a thermal loading of in such a screen is likely to cause a failure of the touch screen, in turn leading to a downtime of the construction machine. Therefore, there is a need for an interactive display system with improved viewing characteristics which is suitable for construction machines, and does not fail in outdoor environment.

### SUMMARY OF THE INVENTION

In one aspect of the present disclosure, an interactive display system is provided. The interactive display system includes a first assembly, a touch screen assembly, and a display assembly. The first assembly further includes a glass sheet having a first surface and a second surface. The glass sheet is etched at one of the first surface and the second surface to provide anti-glare properties to the glass sheet. The first assembly further includes a first coating, a second coating, a third coating, a fourth coating, and a fifth coating. Each of the first coating, the second coating, and the third coating is applied at the first surface of the glass sheet, and each of the fourth coating and the fifth coating is applied at the second surface of the glass sheet. The fourth coating having a predetermined shape and is applied along a perimeter of the glass sheet. The touch screen assembly having a first surface and a second surface. The first surface of the touch screen assembly is optically bonded to the second surface of the glass sheet. The display assembly including a first surface and a second surface. The first surface of the display assembly is optically bonded to the second surface of the touch screen assembly.

Other features and aspects of this disclosure will be apparent from the following description and the accompanying drawings.

### BRIEF DESCRIPTION OF THE DRAWINGS

FIG. 1 shows an interior of an operator cabin for a vehicle having an interactive display system, in accordance with the concepts of the present disclosure;

FIG. 2 shows an exploded side view of the interactive display system of FIG. 1, in accordance with the concepts of the present disclosure;

FIG. 3 shows a schematic diagram of the interactive display system of FIG. 1, in accordance with the concepts of the present disclosure; and

FIG. 4 shows a flowchart for manufacturing the interactive display system of FIG. 1, in accordance with an embodiment of the present disclosure.

### DETAILED DESCRIPTION

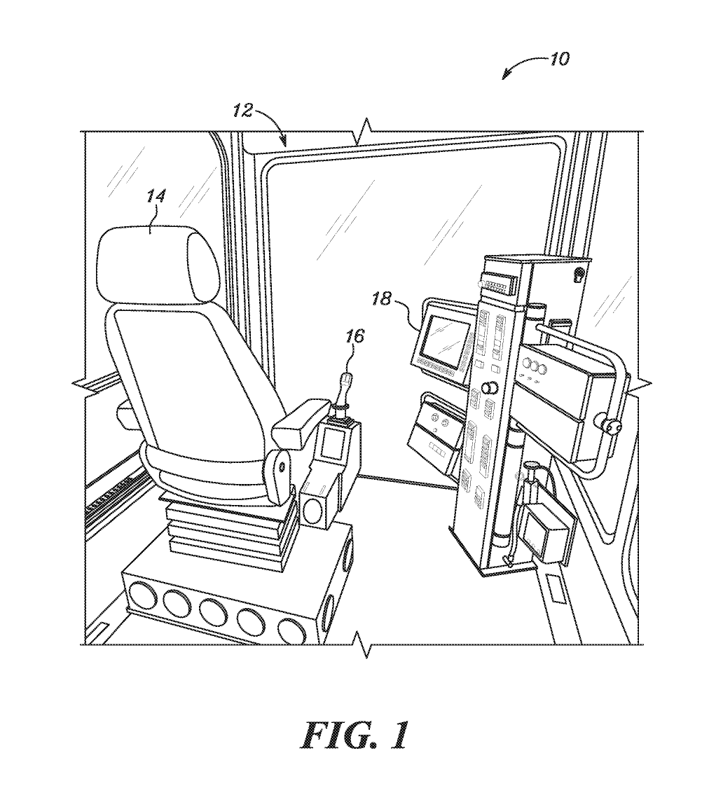

Referring to FIG. 1, a vehicle 10 having an operator cabin 12 is shown. The operator cabin 12 includes a seat 14, a joystick 16, and an interactive display system 18. The seat 14 is used by an operator for sitting and operating the vehicle 10. The joystick 16 is used for controlling and providing input signals to various subsystems (not shown) of the vehicle 10. For example, in case the vehicle 10 is an excavator, the joystick 16 is used for controlling an excavator bucket of the excavator. The interactive display system 18 in the operator cabin 12 is used to display information to the operator. As an example, the interactive display system 18 is used for displaying information, such as, but not limited to, operational parameters of the vehicle 10, an engine temperature of the vehicle 10, a location of the vehicle 10 in a geographic area, a maintenance schedule of the vehicle 10, a warning message, an abnormality occurrence history, a failure occurrence history, a position of a tool of the vehicle 10 etc.

Further, the interactive display system 18 is used by the operator to provide an input to the interactive display system 18. The user provides input to the interactive display system 18 by touching an icon or a visual or symbol or a graphical element displayed on the interactive display system 18. The input provided by the user includes, but is not limited to, a command to control the vehicle 10, a command to control a part of the vehicle 10, a command to control a position of an implement of the vehicle 10, a command to control a Heating Ventilation and Air-Conditioning (HVAC) subsystem in the interior of the operator station of the vehicle 10, a command to control supply of fuel additives etc. The vehicle 10 includes, but not limited to, a miner machine, a track type tractor, or an excavator, a car, a locomotive etc.

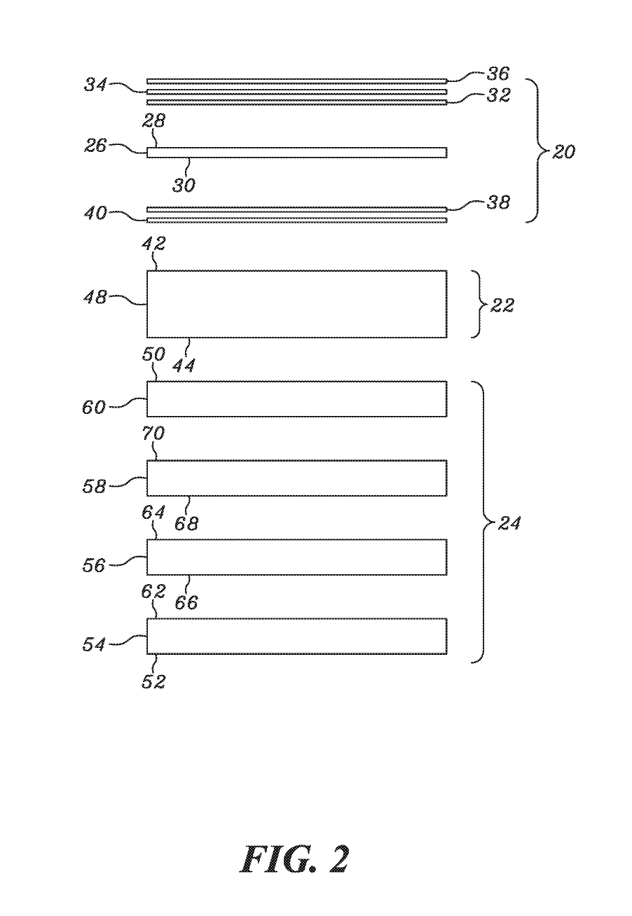

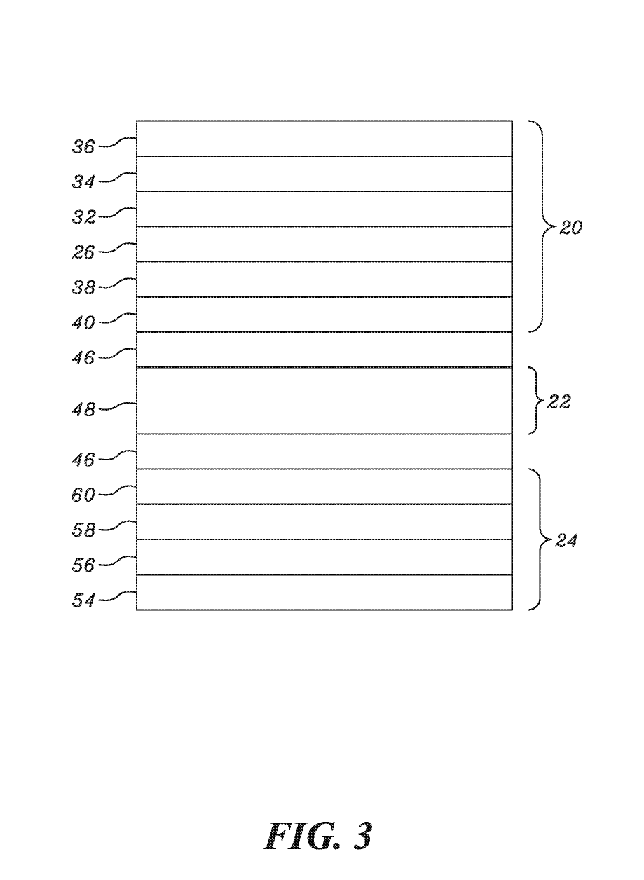

Referring to FIG. 2 and FIG. 3, the interactive display system 18 includes a first assembly 20, a touch screen assembly 22, and a display assembly 24. The first assembly 20 includes a glass sheet 26 having a first surface 28 and a second surface 30. The first assembly 20 further includes a first coating 32, a second coating 34, a third coating 36, a fourth coating 38, and a fifth coating 40. The first coating 32, the second coating 34, and the third coating 36 are applied to the first surface 28 of the glass sheet 26 and the fourth coating 38 and the fifth coating 40 are applied to the second surface 30 of the glass sheet 26. The glass sheet 26 is chemically strengthened to improve strength of the glass sheet 26. Further, the glass sheet 26 is etched to provide anti-glare properties to the glass sheet 26. The etching is performed at the first surface 28 of the glass sheet 26, or at the second surface 30 of the glass sheet 26 or at both the first surface 28 and the second surface 30 of the glass sheet 26. As an example, the etching process is selected from, but not limited to, an acid etching, an etching using an etching cream, and abrasive blasting. Further, the first coating 32 is an infrared reflective coating, which is adapted to reflect the infrared radiations. The second coating 34 is an anti-reflective coating applied to the glass sheet 26, which reduces the reflections and increases the light transmission. The third coating 36 is anti-finger print coating applied to the glass sheet 26.

The second surface 30 of the glass sheet 26 is coated with the fourth coating 38 and the fifth coating 40. The fourth coating 38 has a predetermined shape and is applied along a perimeter of the glass sheet 26. The fourth coating 38 is an opaque black picture frame. As an example, the opaque black picture frame includes an opaque dielectric material, a dark mask, a paint coating etc. The fifth coating 40 is a quarter wave plate adapted to reorient an orientation of a polarized light passing through the glass sheet 26.

The touch screen assembly 22 includes a first surface 42 and a second surface 44. The first surface 42 of the touch screen assembly 22 is optically bonded to the second surface 30 of the glass sheet 26 using an adhesive 46. As an example, an optical-grade adhesive is applied to one of the first surface 42 of the touch screen assembly 22 and the second surface 30 of the glass sheet 26. Thereafter, the touch screen assembly 22 and the glass sheet 26 are bonded to each other. The optical grade adhesive is selected from, but not limited to, silicon, an epoxy, and a polyurethane adhesive. It will be apparent to one skilled in the art that the optical bonding eliminates air gaps between the second surface 30 of the glass sheet 26 and the first surface 42 of the touch screen assembly 22.

The touch screen assembly 22 includes a touch screen 48, which allows a user to provide input to the interactive display system 18. The touch screen 48 is selected from, but not limited to, a capacitive touch screen, a resistive touch screen, a surface wave touch screen, an infrared/thermal touch screen, an optical imaging touch screen, a dispersive signal touch screen, and an acoustic pulse recognition touch screen. It will be apparent to one skilled in art that the touch screen 48 includes additional components such as capacitive sensors electrodes. For the purpose of simplicity, various other components are not described in detail.

The display assembly 24 includes a first surface 50 and a second surface 52. The first surface 50 of the display assembly 24 is optically bonded to the second surface 44 of the touch screen assembly 22 using the adhesive 46. The display assembly 24 further includes a backlight 54, a first linear polarizer 56, a display 58, and a second linear polarizer 60. The backlight 54 includes a first surface 62, and provides illumination across a surface of the interactive display system 18. The backlight 54 includes a light source to emit a light radiation for illuminating the interactive display system 18. As an example, the backlight 54 includes, but not limited to, a LED backlight and a LCD backlight. It will be apparent to one skilled in art, that the backlight 54 may include other components such as a light guide used to guide the light emitted by the backlight 54. For the purpose of simplicity, such other components are not described in detail.

The first linear polarizer 56 includes a first surface 64 and a second surface 66, the first surface 64 of the first linear polarizer 56 is coupled to a second surface 68 of the display 58. As an example, the display 58 is selected from, but not limited to, a TFT-LCD display, a LED display, an OLED display, a LCD display, a Surface-conduction electron-emitter (SED) display. The second liner polarizer 60 is coupled to a first surface 70 of the display 58. The first linear polarizer 56 is a display polarizer that polarizes the light entering the display 58 from the backlight 54. The second linear polarizer 60 is an analyzing polarizer to control (i.e. to block or pass through) light energy emitted through the display 58. Thus, by enabling the light from the backlight 54 to be either transmitted or absorbed, images are formed on the display 58.

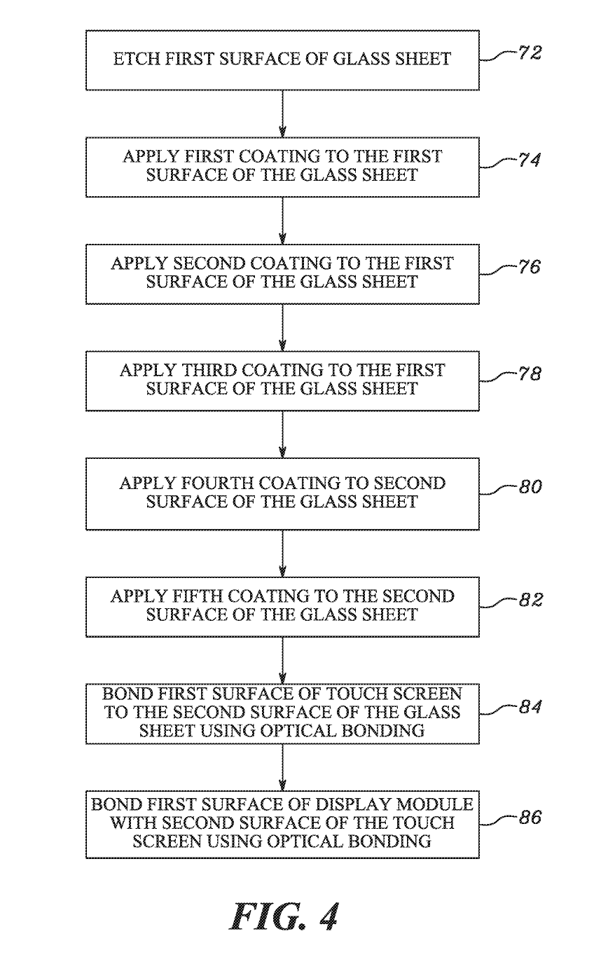

Referring to FIG. 4, a method for manufacturing the interactive display system 18 in accordance with an embodiment of the present disclosure is shown. At step 72, the first surface 28 of the glass sheet 26 is etched. At step 74, the first surface 28 of the glass sheet 26 is coated with the first coating 32. At step 76, the first surface 28 of the glass sheet 26 is coated with the second coating 34. At step 78, the first surface 28 of the glass sheet 26 is coated with the third coating 36. At step 80, the fourth coating 38 is applied to the second surface 30 of the glass sheet 26. At step 82, the fifth coating 40 is applied to the second surface 30 of the glass sheet 26. At step 84, the second surface 30 of the glass sheet 26 is optically bonded using the adhesive 46 to the first surface 42 of the touch screen assembly 22. At step 86, the second surface 44 of the touch screen assembly 22 is optically bonded using the adhesive 46 to the first surface 50 of the display assembly 24.

It will be apparent to one skilled in art that the vehicle 10 is a construction machine such as, but not limited to, a miner machine, a track type tractor, or an excavator, a car, a locomotive. Further, the optical bonding between both, the first assembly 20 and the touch screen assembly 22, and the touch screen assembly 22 and the display assembly 24 is shown using the adhesive 46, however, it will be apparent to a person skilled in art that different optical grade adhesives may be used for optical bonding.

### INDUSTRIAL APPLICABILITY

The present disclosure provides the interactive display system 18 having the first assembly 20. The first assembly 20 includes the glass sheet 26 coated with the first coating 32, the second coating 34, the third coating 36, the fourth coating 38, and the fifth coating 40. The first coating 32 is an infrared reflective coating, which is adapted to reflect the infrared radiations, thereby preventing a failure of the interactive display system 18 due to thermal loading in high ambient light conditions. The second coating 34 is an anti-reflective coating which reduces the reflections and increases the light transmission, to reduce glare and increase light transmission, brightness and contrast of the interactive display system 18. The second coating 34 also helps in minimizing ghost images and multiple reflections. The third coating 36 is anti-finger print coating applied after the first coating 32 and the second coating 34. The anti-fingerprint coating improves the readability and contrast of the interactive display system 18. The anti-fingerprint coating makes the interactive display system 18 resistant to dirt, sweat and oil, so that fingers and dirty gloves will not smudge the glass sheet 26. It also enables easy cleaning of the interactive display system 18.

The fourth coating 38 is an opaque black picture frame, and the fifth coating 40 is a quarter wave plate coating. The opaque black picture frame masks the circuitry of the display assembly 24 and the touch screen assembly 22. Also, quarter wave plate coating is adapted to reorient an orientation of a polarized light passing through the glass sheet 26. The quarter wave plate coating reorients an orientation of the polarized light exiting the display assembly 24 such that the interactive display system 18 does not appear black to a user with polarized sunglasses. The glass sheet 26 is also etched to provide anti-glare properties, thereby, improving the readability of the interactive display system 18 in high ambient light conditions. Further, the first assembly 20, the touch screen assembly 22 and the display assembly 24 are optically bonded with each other, which further increases optical clarity and protects the display from dust and moisture, and reduces parallax. Therefore, the interactive display system 18 achieves high contrast making it easier to read in high ambient light conditions, the interactive display system 18 also works (i.e. does not appear black) with polarized sunglasses in portrait and landscape orientation. The interactive display system 18 also resists thermal loading of the touch screen assembly 22 and display assembly 24. Further, the interactive display system 18 resists fingerprints and is easy to clean.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An interactive display system comprising:
a first assembly including:
a glass sheet having a first surface and a second surface, wherein the glass sheet is etched at at least one of the first surface and the second surface to provide anti-glare properties to the glass sheet;
a first coating;
a second coating;
a third coating;
a fourth coating; and
a fifth coating;
wherein each of the first coating, the second coating and the third coating is applied at the first surface of the glass sheet, and each of the fourth coating and the fifth coating is applied at the second surface of the glass sheet, the fourth coating having a predetermined shape and applied along a perimeter of the glass sheet;
a touch screen assembly having a first surface and a second surface;
wherein the first surface of the touch screen assembly is optically bonded to the second surface of the glass sheet; and
a display assembly having a first surface and a second surface;
wherein the first surface of the display assembly is optically bonded to the second surface of the touch screen assembly.
